(19) United States
(12) Patent Application Publication
(10) Pub. No.: US 2026/0234862 A1
(43) Pub. Date: Aug. 13, 2026

(54) FUNCTIONAL FABRIC

(71) Applicant: Huntertex Corp., Hsinchu City (TW)

(72) Inventors: Cheng-Yi Tai, Hsinchu City (TW); Ching-Hsiang Hsu, Hsinchu City (TW); Wei-Min Su, Hsinchu City (TW)

(21) Appl. No.: 19/439,582

(22) Filed: Jan. 5, 2026

Related U.S. Application Data
(63) Continuation of application No. PCT/CN2023/105627, filed on Jul. 4, 2023.

(51) Int. Cl. D06M 11/83

(52) U.S. Cl. CPC D06M 11/83; D06M 2200/00

(57) ABSTRACT

The present disclosure provides a functional fabric, including a base fabric layer, a multilayer metallic layer and a heat insulation layer. The base fabric layer has a first surface and a second surface opposite to the first surface. The multilayer metallic layer is formed on the first surface of the base fabric layer, and includes a high-heat-conductivity metallic layer and a low-heat-conductivity metallic layer, and a heat transfer coefficient of the high-heat-conductivity metallic layer is 5 times or more of a heat transfer coefficient of the low-heat-conductivity metallic layer. The heat insulation layer is formed on the multilayer metallic layer. A garment made of the functional fabric may achieve the effects of temperature equalization, fast temperature rising and warm keeping.

### CROSS-REFERENCE TO RELATED APPLICATION

This application is a Continuation of PCT/CN2023/105627 filed Jul. 4, 2023, which is incorporated herein by reference in its entirety.

### TECHNICAL FIELD

The present disclosure relates to a functional fabric and a functional yarn, and particularly relates to a functional fabric and a functional yarn with fast temperature rising and warm keeping effects.

### RELATED ART

In the conventional textile technology, in order to provide a garment with a warm keeping effect, a common design thinking is to fill the garment with fluffy fillers such as down feather, natural cotton or polyester cotton to delay body heat dissipation by using the low heat conductivity of air (about 0.025 W/m·° C.), thus achieving the warm keeping effect. The garment made in such a manner has a prominent warm keeping effect, but it may make a user feel uncomfortable in some use scenarios.

By taking a commuter commuting in winter as an example, as shown in FIG. 3, when the person sits in a car with a winter coat 300 (such as a cotton coat, a down feature coat or a wool coat), his/her back usually leans against a seat back 310. The heat conductivity of the winter coat 300 is very low, so the heat radiated out from the back of the person may be fast accumulated (i.e., a position S1) between the seat back 310 and the back of the person, thus causing the uncomfortable feeling such as stuffiness and sweating of the person. The front part (an S2 position) of the coat receives air blown from an air conditioner. Therefore, the chest of the person may not feel stuffy so fast as the back. To avoid the uncomfortable feeling of back stuffiness, the person needs to take off his/her winter coat before getting in a car, or needs to take off his/her coat after sitting on a driver seat if he/she gets in the car with the winter coat. However, as the person sits in the car, and a space of the driver seat is generally narrow, it is unfavorable for putting on or taking off the thick and heavy winter coat. In other words, the person either chooses to tolerate the uncomfortable back feeling of stuffiness and sweating during sitting in the car, or chooses to tolerate inconvenience of frequently putting on or taking off the winter coat.

### SUMMARY

In view of this, the present disclosure provides a functional fabric, including a base fabric layer, a multilayer metallic layer and a heat insulation layer. The base fabric layer has a first surface and a second surface opposite to the first surface. The multilayer metallic layer is formed on the first surface of the base fabric layer, and includes a high-heat-conductivity metallic layer and a low-heat-conductivity metallic layer, and a heat transfer coefficient of the high-heat-conductivity metallic layer is 5 times or more of a heat transfer coefficient of the low-heat-conductivity metallic layer. The heat insulation layer is formed on the multilayer metallic layer.

In some embodiments, the high-heat-conductivity metallic layer of the functional fabric is located between the low-heat-conductivity metallic layer and the base fabric layer.

In some embodiments, the low-heat-conductivity metallic layer of the functional fabric is located between the high-heat-conductivity metallic layer and the base fabric layer.

In some embodiments, the high-heat-conductivity metallic layer of the functional fabric is selected from a group formed by silver, red bronze, brass, aluminum and their combinations.

In some embodiments, the low-heat-conductivity metallic layer of the functional fabric is selected from a group formed by barium, titanium, vanadium, chromium, nickel, germanium, tin, stainless steel and their combinations.

In some embodiments, a thickness of the high-heat-conductivity metallic layer of the functional fabric is in a range between 10 nm and 1,000 nm, and a thickness of the low-heat-conductivity metallic layer is in a range between 10 nm and 1,000 nm.

### BRIEF DESCRIPTION OF THE DRAWINGS

FIG. 1 is a schematic structure diagram of a functional fabric according to an embodiment of the present disclosure.

FIG. 2 is a schematic structure diagram of a functional fabric according to another embodiment of the present disclosure.

FIG. 3 is a schematic diagram of a person wearing a winter coat and sitting in a car.

### DETAILED DESCRIPTION

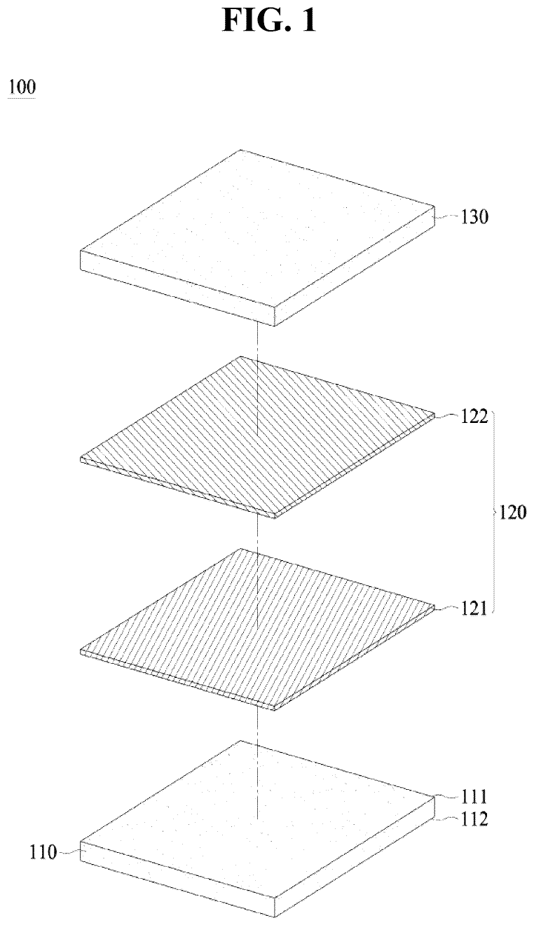

Referring to FIG. 1, FIG. 1 is a schematic structure diagram of a functional fabric 100 according to an embodiment of the present disclosure. The functional fabric 100 includes a base fabric layer 110, a multilayer metallic layer 120 and a heat insulation layer 130. The base fabric layer 110 has a first surface 111 and a second surface 112 opposite to the first surface 111. The multilayer metallic layer 120 is formed on the first surface 111 of the base fabric layer 110 and at least includes a high-heat-conductivity metallic layer 121 and a low-heat-conductivity metallic layer 122. A heat transfer coefficient of the high-heat-conductivity metallic layer 121 is 5 times or more of a heat transfer coefficient of the low-heat-conductivity metallic layer 122. For example, the number of times may be in a range of 5 to 33. The heat insulation layer 130 is formed on the multilayer metallic layer 120. In this embodiment, when a person wears a garment made of the functional fabric 100, the second surface 112 of the base fabric layer 110 faces the human body, so the body heat of the human body may be immediately distributed along the multilayer metallic layer 120 after passing through the base fabric layer 110, and may be blocked by the heat insulation layer 130 in a direction perpendicular to the multilayer metallic layer 120 from being fast dissipated to the outside.

From the above, when the person just wears the garment made of the functional fabric 100, if the current room temperature is 20° C., at this moment, the temperature of the base fabric layer 110 is the same as the room temperature, and the multilayer metallic layer 120 may fast bring away the body heat passing through the base fabric layer 110 due to the material characteristics of the multilayer metallic layer. If the human skin is directly in contact with the base fabric layer 100, the current body feeling when the person just wears the garment is not quite different from that of wearing a common garment. However, the metallic material has the characteristics of high heat conductivity and low heat capacity, under the condition that the body heat is blocked by the heat insulation layer 130 and cannot be fast dissipated in a direction perpendicular to the garment surface, the temperatures of the base fabric layer 110 and the multilayer metallic layer 120 may rise in a short time to reach dynamic balance with the temperature on the surface of the human skin, and the person feels warm. A special emphasis needing to be given here is that compared with a traditional warm keeping garment, the garment made of the functional fabric 100 also has the “warm keeping” effect, and further has the effects such as “temperature equalization” and “fast temperature rising” which are not achieved by the traditional warm keeping garment.

In some embodiments, the base fabric layer 110 equals to a lining fabric commonly called in textile industry, and its material may be nylon, polyethylene terephthalate, nylon/cotton mixed knitting fabric or polyester/cotton mixed knitting fabric. The lining fabric is generally used in an inner layer of a precious garment, for example, an inner layer of a business suit, an overcoat or suit pants, and has the main effects of reducing the uncomfortable feeling of the person caused by direct contact of the skin with surface fabric textures or sewing threads and simultaneously preventing the damage of the inner surface of the surface fabric due to friction with the skin or other clothes. The heat insulation layer 130 may be a surface fabric with laid cotton, a surface fabric filled with the down feather, a wool surface fabric, etc., and may prevent the body heat of the human body from being conducted to the outside in a heat conduction or heat convection mode after passing through the base fabric layer 110 and the multilayer metallic layer 120. The present disclosure focuses on composite performance of “temperature equalization, fast temperature rising and warm keeping” rather than the application in extreme climatic conditions, so heat radiation is not in a discuss scope of the present disclosure.

From the above, the multilayer metallic layer 120 is to at least include a high-heat-conductivity metallic layer 121 and a low-heat-conductivity metallic layer 122, and a reason that a heat transfer coefficient of the high-heat-conductivity metallic layer 121 is to be 5 times or more of a heat transfer coefficient of the low-heat-conductivity metallic layer 122 is that the metallic material has good heat conduction properties, but the heat conduction properties are anisotropic. In order to achieve the composite performance of “temperature equalization, fast temperature rising and warm keeping” in the present disclosure, the metallic layer is added in the lining fabric. However, the too thin thickness of the metallic layer may cause to less heat conduction in unit time, so the poor temperature equalization and fast temperature rising effects may be caused. Therefore, the present disclosure hopes to add a material with “good heat conductivity in a plane direction” but “poor heat conductivity in a vertical direction” into the lining fabric. A material having these characteristics and having commercialization conditions in the nature is graphite or graphene, but due to limitation to its own material characteristics, large-area deposition on the surface of the fabric is difficult to realize on the basis of the existing manufacturing process technology in one aspect, and the reliable attachment of the graphite or graphene to the surface of the fabric is difficult to be expected in the other aspect. In order to lower the heat conductivity of the metallic material with the anisotropic heat conduction properties in the vertical direction, the present disclosure forms at least one heterojunction surface in the vertical direction in a mode of the multilayer metallic layer, this heterojunction surface may form a contact heat resistance interface, and the formed contact heat resistance is greater if the heat conduction coefficient difference of materials at two sides of the interface is greater. Theoretically, the more the metallic layers are included in the multilayer metallic layer 120, the more the heterojunction surfaces may exist, and the higher the integral contact heat resistance may be. However, for each added metal layer, metal deposition process may consume much time and energy, so the increase of the heat conduction coefficient of the material at two sides of the heterojunction surface from material selection will be more economic than the formation of multiple metallic layers. Therefore, the heat transfer coefficient of the high-heat-conductivity metallic layer 121 is to be 5 times or more of the heat transfer coefficient of the low-heat-conductivity metallic layer 122. For example, the value may be 5 to 33 times.

As shown in FIG. 1, the high-heat-conductivity metallic layer 121 is located between the low-heat-conductivity metallic layer 122 and the base fabric layer 110. In other words, when being conducted in a direction perpendicular to the base fabric layer 110, the body heat may firstly reach the high-heat-conductivity metallic layer 121, then passes through the high-heat-conductivity metallic layer to reach the low-heat-conductivity metallic layer 122, and next passes through the low-heat-conductivity metallic layer 122 to be blocked by the heat insulation layer 130. In some embodiments, the high-heat-conductivity metallic layer may be selected from silver, red bronze, brass and aluminum, and the low-heat-conductivity metallic layer may be selected from barium, titanium, vanadium, chromium, nickel, germanium, tin and stainless steel. In some embodiments, a thickness of the high-heat-conductivity metallic layer is in a range between 10 nm and 1,000 nm, and a thickness of the low-heat-conductivity metallic layer is in a range between 10 nm and 1,000 nm. In some other embodiments, a thickness of the high-heat-conductivity metallic layer of the functional fabric is in a range between 50 nm and 500 nm, and a thickness of the low-heat-conductivity metallic layer is in a range between 50 nm and 250 nm.

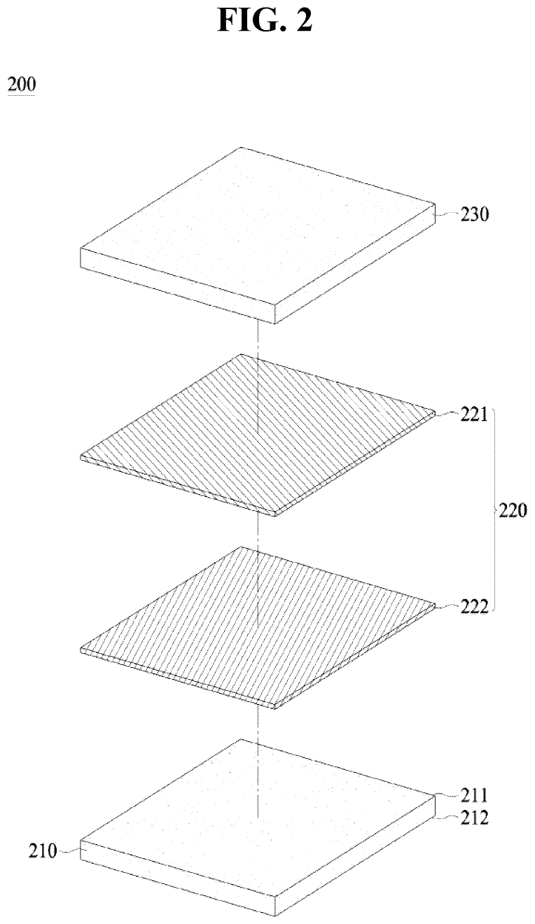

Referring to FIG. 2, it shows an example functional fabric 200 also including a base fabric layer 210, a multilayer metallic layer 220 and a heat insulation layer 230. Compared with the functional fabric 100, the functional fabric 200 is characterized in that a low-heat-conductivity metallic layer 222 is located between a high-heat-conductivity metallic layer 221 and the base fabric layer 210. In other words, when being conducted in a direction perpendicular to the base fabric layer 210, the body heat may firstly reach the low-heat-conductivity metallic layer 222, then reaches the high-heat-conductivity metallic layer 221, and is next blocked by the heat insulation layer 230.

Experiment results show that the functional fabric 100 and the functional fabric 200 may both realize the composite performance of “temperature equalization, fast temperature rising and warm keeping”. During simulation under the same working conditions, the garments made of the functional fabric 100 and the functional fabric 200 have the same temperature gradient distribution. Compared with a person wearing the garment made of the functional fabric 200, a person wearing the garment made of the functional fabric 100 may feel a little more cool feeling when just contacting the garment at the early stage if he/she is a person with a keen skin touch sense, but these little and short body feeling differences may fast disappear with the fast temperature rise of the functional fabric.

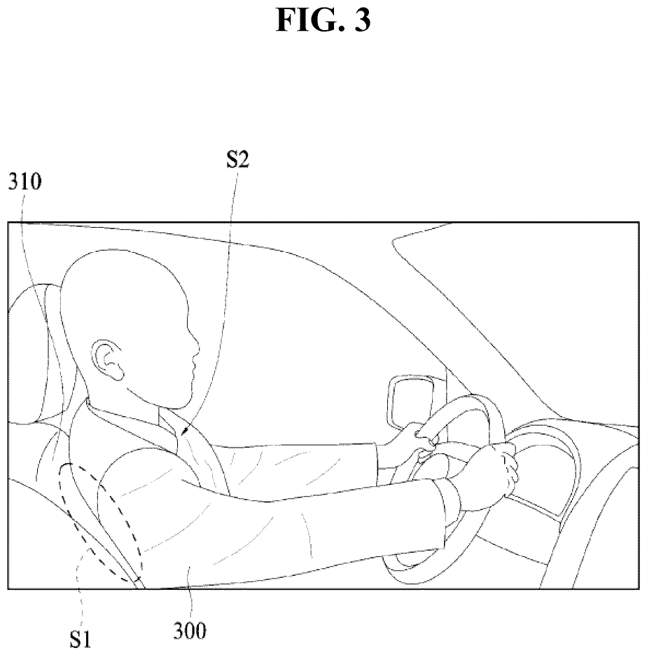

Referring to FIG. 3 again, the present disclosure may specifically achieve the effect in this use scenario. As mentioned above, when a person sits in a car with the winter coat 300, his/her back easily gets uncomfortable feeling such as stuffiness and sweating. If the winter coat is made of the functional fabric 100 or the functional fabric 200 disclosed by the above embodiments, the heat in the position S1 may be easily conducted to the position S2, and may be then dissipated to the outside through being blown by air from an air conditioner. Therefore, the heat accumulation condition (i.e., the position S1) between a seat back 310 and the back of the person is greatly reduced, the problems that the person needs to tolerate the uncomfortable back feeling of stuffiness and sweating with the winter coat during sitting in the car, or the person needs to tolerate inconvenience of frequently putting on or taking off the winter coat when getting in or getting off the car are effectively solved.

Based on the extension of the above effects, the problem of any local stuffy feeling caused by wearing the winter cloth may be solved through the functional fabric 100 or 200 with the composite performance of “temperature equalization, fast temperature rising and warm keeping” according to the present disclosure. For example, when the person with a traditional winter garment sits in an electric multiple unit (EMU) with a seat heating function, he/she may not feel stuffy at the beginning because he/she just enters the warm carriage from a cold environment. However, with the time sitting in the carriage increases, the body heat may start to be accumulated in a position of the human body in contact with the seat. For example, at this moment, parts such as the hip or the back may feel stuffy. If the person wears the winter garment made of the functional fabric 100 or 200, the stuffy feeling may be effectively eliminated or relived.

The above embodiments are merely used to illustrate the technical ideas and characteristics of this application, are intended to help those skilled in the art to understand the contents of this application and implement this application but may not limit the patent scope of this application. That is, the equivalent changes or modifications made in accordance with the spirits of this application are to be within the patent scope of this application.

What is claimed is:

1. A functional fabric, comprising:
a base fabric layer, having a first surface and a second surface opposite to the first surface;
a multilayer metallic layer, formed on the first surface of the base fabric layer and comprising a high-heat-conductivity metallic layer and a low-heat-conductivity metallic layer, a heat transfer coefficient of the high-heat-conductivity metallic layer being 5 times or more of a heat transfer coefficient of the low-heat-conductivity metallic layer; and
a heat insulation layer, formed on the multilayer metallic layer.

2. The functional fabric according to claim 1, wherein a ratio of the heat transfer coefficient of the high-heat-conductivity metallic layer to the heat transfer coefficient of the low-heat-conductivity metallic layer is in a range between 5 and 33.

3. The functional fabric according to claim 2, wherein the high-heat-conductivity metallic layer is selected from a group formed by silver, red bronze, brass, aluminum and their combinations.

4. The functional fabric according to claim 3, wherein the low-heat-conductivity metallic layer is selected from a group formed by barium, titanium, vanadium, chromium, nickel, germanium, tin, stainless steel and their combinations.

5. The functional fabric according to claim 4, wherein a thickness of the high-heat-conductivity metallic layer is in a range between 10 nm and 1,000 nm, and a thickness of the low-heat-conductivity metallic layer is in a range between 10 nm and 1,000 nm.

6. The functional fabric according to claim 5, wherein a thickness of the high-heat-conductivity metallic layer is in a range between 50 nm and 250 nm, and a thickness of the low-heat-conductivity metallic layer is in a range between 50 nm and 250 nm.

7. The functional fabric according to claim 1, wherein the high-heat-conductivity metallic layer is located between the low-heat-conductivity metallic layer and the base fabric layer.

8. The functional fabric according to claim 7, wherein the high-heat-conductivity metallic layer is selected from a group formed by silver, red bronze, brass, aluminum and their combinations.

9. The functional fabric according to claim 8, wherein the low-heat-conductivity metallic layer is selected from a group formed by barium, titanium, vanadium, chromium, nickel, germanium, tin, stainless steel and their combinations.

10. The functional fabric according to claim 9, wherein a thickness of the high-heat-conductivity metallic layer is in a range between 10 nm and 1,000 nm, and a thickness of the low-heat-conductivity metallic layer is in a range between 10 nm and 1,000 nm.

11. The functional fabric according to claim 10, wherein a thickness of the high-heat-conductivity metallic layer is in a range between 50 nm and 250 nm, and a thickness of the low-heat-conductivity metallic layer is in a range between 50 nm and 250 nm.

12. The functional fabric according to claim 1, wherein the low-heat-conductivity metallic layer is located between the high-heat-conductivity metallic layer and the base fabric layer.

13. The functional fabric according to claim 12, wherein the high-heat-conductivity metallic layer is selected from a group formed by silver, red bronze, brass, aluminum and their combinations.

14. The functional fabric according to claim 13, wherein the low-heat-conductivity metallic layer is selected from a group formed by barium, titanium, vanadium, chromium, nickel, germanium, tin, stainless steel and their combinations.

15. The functional fabric according to claim 14, wherein a thickness of the high-heat-conductivity metallic layer is in a range between 10 nm and 1,000 nm, and a thickness of the low-heat-conductivity metallic layer is in a range between 10 nm and 1,000 nm.

16. The functional fabric according to claim 15, wherein a thickness of the high-heat-conductivity metallic layer is in a range between 50 nm and 250 nm, and a thickness of the low-heat-conductivity metallic layer is in a range between 50 nm and 250 nm.

17. The functional fabric according to claim 1, wherein the high-heat-conductivity metallic layer is selected from a group formed by silver, red bronze, brass, aluminum and their combinations.

18. The functional fabric according to claim 1, wherein the low-heat-conductivity metallic layer is selected from a group formed by barium, titanium, vanadium, chromium, nickel, germanium, tin, stainless steel and their combinations.

19. The functional fabric according to claim 1, wherein a thickness of the high-heat-conductivity metallic layer is in a range between 10 nm and 1,000 nm, and a thickness of the low-heat-conductivity metallic layer is in a range between 10 nm and 1,000 nm.

20. The functional fabric according to claim 1, wherein a thickness of the high-heat-conductivity metallic layer is in a range between 50 nm and 250 nm, and a thickness of the low-heat-conductivity metallic layer is in a range between 50 nm and 250 nm.
